(19) United States
(12) Patent Application Publication
(10) Pub. No.: US 2019/0109366 A1
(43) Pub. Date: Apr. 11, 2019

(54) DOUBLE-FED TUNABLE TERMINAL ANTENNA BASED ON METAL REAR SHELL

(71) Applicant: ZTE CORPORATION, Shenzhen (CN)

(72) Inventor: Xiaoqi CHENG, Shenzhen (CN)

(21) Appl. No.: 16/089,657

(22) PCT Filed: May 24, 2016
(86) PCT No.: PCT/CN2016/083152

§ 371 Date: Sep. 28, 2018

(30) Foreign Application Priority Data
Mar. 29, 2016 (CN) 201610188108.7

(51) Int. Cl. H01Q 1/24; H01Q 5/35; H01Q 1/38; H01Q 1/48; H01Q 1/40; H04M 1/02

(52) U.S. Cl. CPC H01Q 1/243; H01Q 5/35; H04M 1/0274; H01Q 1/48; H01Q 1/40; H01Q 1/38

(57) ABSTRACT

A double-fed tunable terminal antenna based on a metal rear shell is provided. The antenna includes: a Printed Circuit Board (PCB); a metal rear shell, on which two gaps are set, and the two gaps divide the metal rear shell into three parts, one of three parts serves as an antenna radiation unit; a grounding element, connected with the metal rear shell; and two feed matching networks and corresponding two feed points, the two feed matching networks are fed into the antenna radiation unit through the corresponding two feed points.

### TECHNICAL FIELD

The disclosure relates to antenna technologies, and in particular to a double-fed tunable terminal antenna based on a metal rear shell.

### BACKGROUND

With the rapid development of the 4^{th} Generation (4G) communication technologies, more and more mobile terminals support the 4G network, which requires a wider bandwidth of an antenna to meet users' requirements. On the other hand, with the further popularization of 4G terminals, the homogeneity of cellphones becomes increasingly serious, and the requirements of people on cellphones become more and more critical, such as the texture of cellphone body, and the Internet experience of users. For this reason, a lot of cellphone manufactures launch metal cellphones. An all-metal integrated cellphone is loved by customers due to its attractive and fashionable appearance, for example, iphone6 and Mate S. While improving the texture and level of the cellphone, because the metal has a natural signal shielding characteristic, the performance of the antenna is degraded. In order not to impact the user experience while satisfying the 4G standard, a huge challenge is brought up for the antenna design.

In order not to impact the performance of antenna, the performance of antenna may be realized by slotting on a metal rear shell. However, forming a lot of slots affects aesthetics. Moreover, a complex tuning switch, an antenna stand unit, a related electrical connector and various reserved ground feed points are introduced, which certainly occupies more space and increases the design cost and complexity.

### SUMMARY

Embodiments of the disclosure provide a double-fed tunable terminal antenna based on a metal rear shell.

The double-fed tunable terminal antenna based on a metal rear shell which is provided by the embodiments of the disclosure includes: a Printed Circuit Board (PCB); a metal rear shell, on which two gaps are set, and the two gaps divide the metal rear shell into three parts, one of three parts serves as an antenna radiation unit; a grounding element, connected with the metal rear shell; and two feed matching networks and corresponding two feed points, the two feed matching networks are fed into the antenna radiation unit through the corresponding two feed points.

In the embodiments of the disclosure, the PCB includes a dielectric substrate and a metal ground with copper poured on surface.

In the embodiments of the disclosure, two gaps are set on the metal rear shell, the two gaps divide the metal rear shell into three parts, one of three parts serves as the antenna radiation unit.

Specifically, the metal rear shell is divided by the two gaps which are symmetrical and equally wide into three parts as follows: the bottom metal rear shell, the middle metal rear shell and the top metal rear shell.

The bottom metal rear shell serves as the antenna radiation unit, and the antenna radiation unit is above a clearance area of the PCB.

In the embodiments of the disclosure, the grounding element connects the middle metal rear shell with the metal ground of the PCB.

In the embodiments of the disclosure, the range of width of the two gaps which are symmetrical and equally wide is from 1 mm to 2 mm, the three parts of metal rear shell are connected by means of injection molding in the gaps.

In the embodiments of the disclosure, the two feed matching networks are fed into the antenna radiation unit through the corresponding two feed points.

Specifically, the two feed matching networks are fed into the bottom metal rear shell through the corresponding two feed points.

In the embodiments of the disclosure, both of the two feed matching networks are on the dielectric substrate of the PCB, both of the two feed matching networks are composed of an inductor and a capacitor or an adjustable capacitor, the first feed matching network of the two feed matching networks works in a high-frequency working frequency range, the second feed matching network of the two feed matching networks includes an adjustable capacitor, the adjustable capacitor is configured for tuning a low-frequency working frequency range of the antenna, the two feed matching networks are fed through two signal feed ports on the PCB.

In the embodiments of the disclosure, the two feed matching networks are fed into the antenna radiation unit through the corresponding two feed points.

Specifically, two signals feed the bottom metal rear shell through the two feed matching networks and via the two feed points, so that the bottom metal rear shell forms the antenna radiation unit.

In the embodiments of the disclosure, a Universal Serial Bus (USB) and a clearance area are set below the bottom metal rear shell, the USB is connected with the metal ground of the PCB, the two feed matching networks and the corresponding two feed points are respectively at left and right sides of the USB.

In the embodiments of the disclosure, the distance from the first feed point of the two feed points to the center line of the USB is 13 mm to 15 mm, and the distance from the second feed point of the two feed points to the center line of the USB is 9 mm to 11 mm.

According to the technical solutions of the disclosure, the antenna radiation unit based on a metal rear shell and the two feed matching networks are combined, by adopting a form of double-signal feed, signals are introduced via two signal feed ports, and then fed into the antenna radiation unit by the two feed matching networks via the corresponding feed points. In such a manner, the working frequency range of 698-960 MHz and the working frequency range of 1710-2690 MHz are achieved. The low frequency 698-960 MHz is achieved by adopting a simple tuning form, thereby further increasing the frequency bandwidth, and meeting the requirement of the existing terminal for 4G multiband standard. Moreover, in the above technical solutions, only the metal rear shell and the matching networks are used, so the occupied space is small. In the meanwhile, there is no extra antenna branch and tuning switch, so the cost is saved, and the design is simple and practicable. The technical solutions may be suitably applied to the design of the terminal antenna based on a metal rear shell.

### BRIEF DESCRIPTION OF DRAWINGS

FIG. 1 is a schematic diagram of an overall model of a double-fed tunable terminal antenna based on a metal rear shell according to the embodiments of the disclosure.

FIG. 2 is a circuit diagram of the first feed matching network of two feed matching networks according to the embodiments of the disclosure.

FIG. 3 is a circuit diagram of the second feed matching network of two feed matching networks according to the embodiments of the disclosure.

FIG. 4 is a curve graph of a return loss according to the embodiments of the disclosure.

### DETAILED DESCRIPTION

For better understanding of the features and technical contents in the embodiments of the disclosure, the embodiments of the disclosure are elaborated in combination with the accompanying drawings. The accompanying drawings are only provided for purpose of explanation, but not intended to limit the embodiments of the disclosure.

The embodiments of the disclosure provide a double-fed tunable terminal antenna based on a metal rear shell. In the technical solutions of the disclosure, a antenna radiation unit based on a metal rear shell and two feed matching networks are combined, by adopting the form of double-signal feed, a signal is fed into the metal rear shell via the two feed matching networks; in such a manner, the working frequency range with an antenna bandwidth of 698-960 MHz and the working frequency range with an antenna bandwidth of 1710-2690 MHz are achieved. The low frequency 698-960 MHz is achieved by adopting the simple tuning form, thereby further increasing the frequency bandwidth. In the meanwhile, in the technical solutions of the disclosure, there is no extra antenna branch and tuning switch, so the cost is saved, and the design is simple and practicable. The technical solutions may be applied to the design of the cellphone antenna based on a metal rear shell well.

The double-fed tunable terminal antenna based on a metal rear shell which is provided by the embodiments of the disclosure includes:

a Printed Circuit Board (PCB);

a metal rear shell, on which two gaps are set, and the two gaps divide the metal rear shell into three parts, one of three parts serves as an antenna radiation unit;

a grounding element, connected with the metal rear shell; and

two feed matching networks and corresponding two feed points, the two feed matching networks are fed into the antenna radiation unit through the corresponding two feed points.

The PCB includes a dielectric, substrate and a metal ground with copper poured on surface.

Two gaps are set on the metal rear shell, the two gaps divide the metal rear shell into three parts, one of three parts serves as the antenna radiation unit.

Specifically, the metal rear shell is divided by the two gaps which are symmetrical and equally wide into three parts as follows: a bottom metal rear shell, a middle metal rear shell and a top metal rear shell.

The bottom metal rear shell serves as the antenna radiation unit, and the antenna radiation unit is above a clearance area of the PCB.

The grounding element connects the middle metal rear shell with the metal ground of the PCB.

The range of width of the two gaps which are symmetrical and equally wide is from 1 mm to 2 mm, the three parts of metal rear shell are connected by means of injection molding in the gaps.

The two feed matching networks are fed into the antenna radiation unit through the corresponding two feed points.

Specifically, the two feed matching networks are fed into the bottom metal rear shell through the corresponding two feed points.

Both of the two feed matching networks are on the dielectric substrate of the PCB, both of the two feed matching networks are composed of an inductor and a capacitor or an adjustable capacitor, the first feed matching network of the two feed matching networks works in a high-frequency working frequency range, the second feed matching network of the two feed matching networks includes an adjustable capacitor, the adjustable capacitor is configured for tuning a low-frequency working frequency range of the antenna, the two feed matching networks are fed through two signal feed ports on the PCB.

The two feed matching networks are fed into the antenna radiation unit through the corresponding two feed points.

Specifically, two signals feed the bottom metal rear shell through the two feed matching networks and via the two feed points, so that the bottom metal rear shell forms the antenna radiation unit.

A Universal Serial Bus (USB) and a clearance area are set below the bottom metal rear shell, the USB is connected with the metal ground of the PCB, the two feed matching networks and the corresponding two feed points are respectively at left and right sides of the USB.

The distance from the first feed point of the two feed points to the center line of the USB is 13 mm to 15 mm, and the distance from the second feed point of the two feed points to the center line of the USB is 9 mm to 11 mm.

The double-fed tunable terminal antenna based on a metal rear shell of the disclosure is further elaborated below in combination with the specific embodiments.

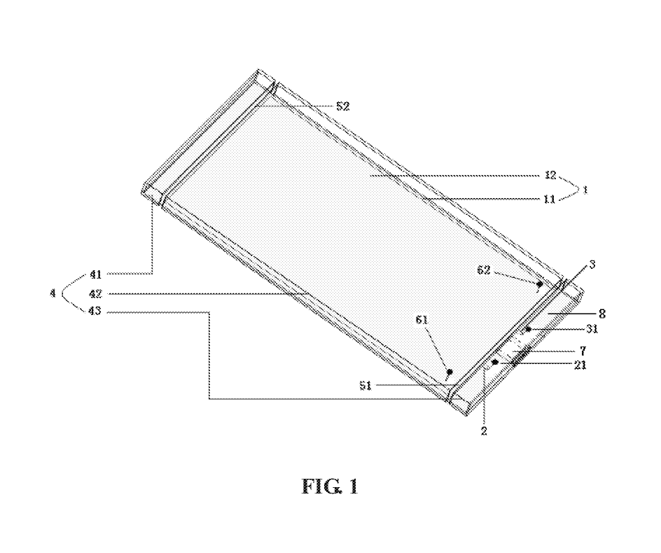

FIG. 1 is a schematic diagram of an overall model of the double-fed tunable terminal antenna based on a metal rear shell according to the embodiments of the disclosure. In an example, the antenna is applied to the cellphone. Of course, those skilled in the art should understand that the double-fed tunable terminal antenna based on a metal rear shell according to the embodiments of the disclosure may also be applied to other types of terminals, for example, a PAD.

In FIG, 1, the antenna includes: the PCB 1 and the metal rear shell 4. A pair of symmetrical first gap 51 and second gap 52 are set on the metal rear shell 4. The bottom metal rear shell 43, which is separated by the first gap 51, serves as the antenna radiation unit. The other two parts of the metal rear shell are the middle metal rear shell 42 and the top metal rear shell 41.

The antenna also includes two grounding elements, i.e. the first grounding element 61 and the second grounding element 62. The two feed matching networks are respectively the first feed matching network 2 and the second feed matching network 3. The corresponding two feed points are respectively the first feed point 21 and the second feed point 31. The first feed matching network 2 is fed into the antenna radiation unit (the bottom metal rear shell 43) via the first feed point 21. The second feed matching network 3 is fed into the antenna radiation unit (the bottom metal rear shell 43) via the second feed point 31.

The antenna also includes the USB 7 and the clearance area 8.

In some embodiments, the periphery dimension of the metal rear shell 4 is 152 mm×75 mm×7 mm. The thickness of the metal rear shell 4 is 0.8 mm. The PCB 1 includes the dielectric substrate 11 and the metal ground with copper poured on surface 12. The antenna radiation unit is the bottom metal rear shell 43, which is above the clearance area 8 of the PCB 1. Both the periphery dimensions of the bottom metal rear shell 43 and the top metal rear shell 41 are 75 mm×9 mm×7 mm. The first grounding element 61 and the second grounding element 62 connect the middle metal rear shell 42 with the metal ground of the PCB 1. The first grounding element 61 and the second grounding element 62 may be realized by means of a metal elastic piece. The range of width of the first gap 51 and the second gap 52 which are symmetrical is from 1 mm to 2 mm. In the first embodiment, both the widths of the first gap 51 and the second gap 52 are 1.8 mm. The first gap 51 and the second gap 52 adopt an in-mold injection molding way to make the metal rear shell form as a whole. The USB 7 and the clearance area 8 are distributed below the bottom metal rear shell 43. The USB 7 is connected with the metal ground 12 of the PCB 1. Two signals access the two feed points (the first feed point 21 and the second feed point 31) of the bottom metal rear shell 43. The two feed points are respectively at the left and right sides of the USB 7. The distance from the first feed point 21 to the center line of the USB 7 is 13 mm to 15 mm, and the distance from the second feed point 31 to the center line of the USB 7 is 9 mm to 11 mm.

Both of the first feed matching network 2 and the second feed matching network 3 are on the dielectric substrate 11, and are composed of the inductor, the capacitor or the adjustable capacitor. The first feed matching network 2 contributes to the high-frequency working frequency range (1710-2690 MHz) of the antenna. The second feed matching network 3 includes the adjustable capacitor for tuning the low-frequency working frequency range (698-960 MHz) of the antenna. The first feed matching network 2 and the second feed matching network 3 are respectively fed via the two signal feed ports on the PCB1. The first feed point 21 and the second feed point 31 corresponding to the first feed matching network 2 and the second feed matching network 3 access the antenna radiation unit 43.

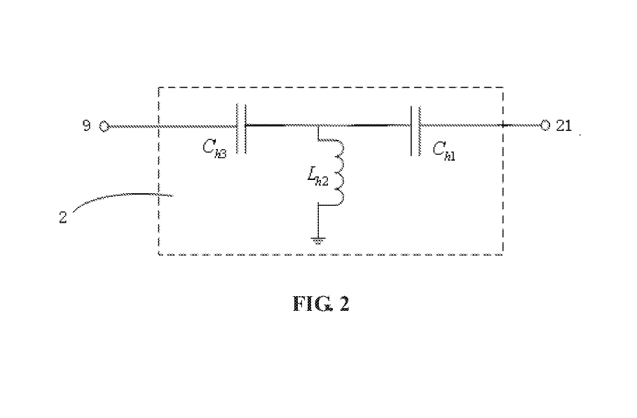

FIG. 2 is a circuit diagram of the first feed matching network of the two feed matching networks according to the embodiments of the disclosure. As shown in FIG. 2, the first feed matching network 2, which is composed of series capacitors and shunt inductors, is on the dielectric substrate and is fed via a radio frequency co-axial feed port 9. The feed matching network has the characteristics of passing high frequency and resisting low frequency, and mainly makes a contribution to the high frequency (1710-2690 MHz) part of the antenna. By optimizing the value of each element, the high-frequency bandwidth and in-band performance may be improved, For example, the resonance at the high frequency 2 GHz is deepened by appropriately reducing the shunt inductor Lₕ₂; the high-frequency bandwidth may be increased by appropriately increasing the value of the series capacitor Cₕ₃ without influencing the low frequency.

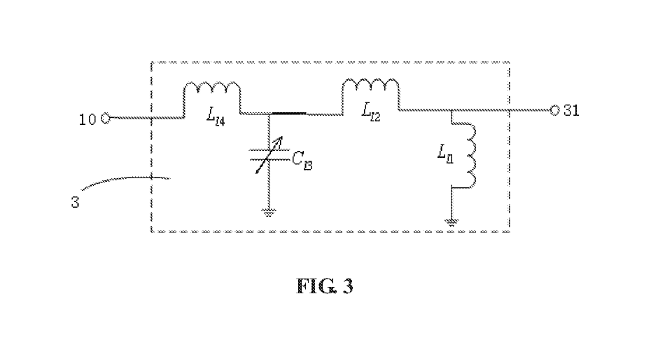

FIG. 3 is a circuit diagram of the second feed matching network of the two feed matching networks according to the embodiments of the disclosure. As shown in FIG. 3, the second feed matching network 3 is on the dielectric substrate and is fed via the radio frequency co-axial feed port 10, and the second feed matching network 3 is composed of inductors connected in series or in parallel, and adjustable capacitors connected in parallel. The feed matching network has the characteristics of passing low frequency and resisting high frequency, and mainly adjusts the low frequency (698-960 MHz) part of the antenna. By optimizing the value of each element, a low-frequency bandwidth and an in-band return loss may be changed. C₁₃ is the adjustable capacitor. A low-frequency resonant frequency point may be adjusted by appropriately adjusting the value of C₁₃. For example, when C₁₃ is 3.5 pF, the low-frequency resonance is 800 MHz, which may suitably cover 698-894 MHz; when C₁₃ is 2.7 pF, the low-frequency resonance is 900 MHz, which may suitably cover 800-960 MHz. Thus, the low-frequency bandwidth of the antenna may be broadened, while the high frequency does not change significantly.

In the embodiments of the disclosure, for meeting the requirements for frequency bands, the positions of the first feed point 21 and the second feed point 31 may be adjusted appropriately. Moreover, the performance of the antenna may be further optimized by appropriately adjusting the position of a ground point. For example, the high-frequency and low-frequency bandwidths and resonance of the antenna may also be optimized by changing the positions of the first grounding element 61 and the second grounding element 62.

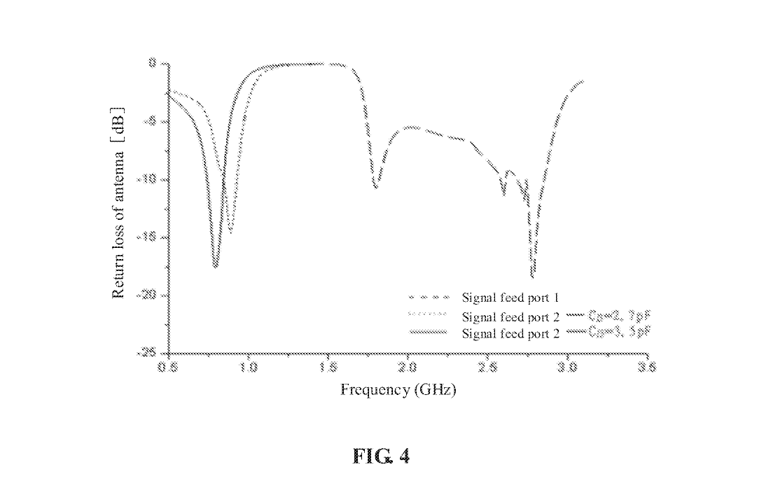

FIG. 4 is a curve graph of a return loss according to the embodiments of the disclosure. As shown in FIG. 4, two signals are introduced. The two signals are fed into the antenna radiation unit respectively through two new-type feed matching networks. The antenna is enabled to have two resonant frequency bands by simply tuning, which increases the bandwidth of the antenna, so the whole Long Term Evolution (LTE) working frequency range, namely 698-960 MHz and 1710-2690 MHz, may be suitably covered. Besides, the return loss in either of the two passbands is less than −6 dB, and the isolation of the two passbands is high, which meet the technical requirements of the antenna of the broadband 4G cellphone in the mobile communications. Compared with other realization forms of the cellphone antenna based on a metal rear shell, the technical solutions of the embodiments of the disclosure have advantages of being simple and practicable to design, without needing extra tuning switch, and having the wider antenna bandwidth. The technical solutions may be applied to the design of antenna of the existing all-metal cellphone.

The double-fed tunable terminal antenna based on a metal rear shell according to the embodiments of the disclosure may be arranged in various mobile terminals. The mobile terminals may be implemented in a variety of forms. For example, the terminals described in the embodiments of the disclosure may include: a cellphone, a smartphone, a digital broadcast receiver, a Personal Digital Assistant (PDA), a PAD, a Portable Media Player (PMP), a navigation unit, and so on.

The above is only the preferred embodiments of the disclosure and not intended to limit the disclosure. For those skilled in the art, the disclosure may have various modifications and changes, for example, the number of the ground points may also be two or four. Any modifications, equivalent replacements, improvements and the like within the principle of the disclosure shall fall within the scope of the disclosure.

### INDUSTRIAL APPLICABILITY

In the technical solutions of the disclosure, the antenna radiation unit based on a metal rear shell and the two feed matching networks are combined, by adopting the double-signal feed form, signals are introduced via two signal feed ports, and then fed into the antenna radiation unit by the two feed matching networks via the corresponding feed points. In such a manner, the working frequency range with an antenna bandwidth of 698-960 MHz and the working frequency range with an antenna bandwidth of 1710-2690 MHz are achieved. The low frequency 698-960 MHz is achieved by adopting a simple tuning form, thereby further increasing the frequency bandwidth, and meeting the requirement of the existing terminal for 4G multiband standard. Moreover, in the above technical solutions, only the metal rear shell and the matching networks are used, so the occupied space is small. In the meanwhile, there is no extra antenna branch and tuning switch, so the cost is saved, and the design is simple and practicable. The technical solutions may be suitably applied to the design of the terminal antenna based on a metal rear shell.

1. A double-fed tunable terminal antenna based on a metal rear shell, comprising:
a Printed Circuit Board (PCB);
a metal rear shell, on which two gaps are set, and the two gaps divide the metal rear shell into three parts, one of three parts serves as an antenna radiation unit;
a grounding element, connected with the metal rear shell; and
two feed matching networks and corresponding two feed points, the two feed matching networks are fed into the antenna radiation unit through the corresponding two feed points.

2. The double-fed tunable terminal antenna based on a metal rear shell according to claim 1, wherein the PCB comprises a dielectric substrate and a metal ground with copper poured on surface.

3. The double-fed tunable terminal antenna based on a metal rear shell according to claim 2, wherein two gaps are set on the metal rear shell, the two gaps divide the metal rear shell into three parts, one of three parts serves as the antenna radiation unit;
the metal rear shell is divided by the two gaps which are symmetrical and equally wide into three parts as follows: a bottom metal rear shell, a middle metal rear shell and a top metal rear shell;
the bottom metal rear shell serves as the antenna radiation unit, and the antenna radiation unit is above a clearance area of the PCB.

4. The double-fed tunable terminal antenna based on a metal rear shell according to claim 3, wherein the grounding element connects the middle metal rear shell with the metal ground of the PCB.

5. The double-fed tunable terminal antenna based on a metal rear shell according to claim 3, wherein the range of width of the two gaps which are symmetrical and equally wide is from 1 mm to 2 mm, the three parts of metal rear shell are connected by means of injection molding in the gaps.

6. The double-fed tunable terminal antenna based on a metal rear shell according to claim 3, wherein the two feed matching networks are fed into the antenna radiation unit through the corresponding two feed points;
the two feed matching networks are fed into the bottom metal rear shell through the corresponding two feed points.

7. The double-fed tunable terminal antenna based on a metal rear shell according to claim 3, wherein,
both of the two feed matching networks are on the dielectric substrate of the PCB, both of the two feed matching networks are composed of an inductor and a capacitor or an adjustable capacitor, the first feed matching network of the two feed matching networks works in a high-frequency working frequency range, the second feed matching network of the two feed matching networks comprises an adjustable capacitor, the adjustable capacitor is configured for tuning a low-frequency working frequency range of the antenna, the two feed matching networks are fed through two signal feed ports on the PCB.

8. The double-fed tunable terminal antenna based on a metal rear shell according to claim 3, wherein the two feed matching networks are fed into the antenna radiation unit through the corresponding two feed points;
two signals feed the bottom metal rear shell through the two feed matching networks and via the two feed points, so that the bottom metal rear shell forms the antenna radiation unit.

9. The double-fed tunable terminal antenna based on a metal rear shell according to claim 3, wherein,
a Universal Serial Bus (USB) and a clearance area are set below the bottom metal rear shell, the USB is connected with the metal ground of the PCB, the two feed matching networks and the corresponding two feed points are respectively at left and right sides of the USB.

10. The double-fed tunable terminal antenna based on a metal rear shell according to claim 9, wherein the distance from the first feed point of the two feed points to the center line of the USB is 13 mm to 15 mm, and the distance from the second feed point of the two feed points to the center line of the USB is 9 mm to 11 mm.
